(19) United States
(12) Patent Application Publication
(10) Pub. No.: US 2014/0298618 A1
(43) Pub. Date: Oct. 9, 2014

(54) HINGE WITH AN ADHESIVE

(71) Applicant: Peter Karonis, Birmingham, MI (US)

(72) Inventor: Peter Karonis, Birmingham, MI (US)

(21) Appl. No.: 13/859,351

(22) Filed: Apr. 9, 2013

(51) Int. Cl. E05D 11/00; E05D 5/10

(52) U.S. Cl. CPC E05D 11/00; E05D 5/10
USPC 16/386; 16/387

(57) ABSTRACT

A hinge device with an adhesive for attachment. The present invention may include a hinge with a first leaf and a second leaf rotatably attached together. The first leaf and the second leaf may each include an adhesive. The adhesive may be used to connect the hinge to a first component and a second component and thereby hinge together the first component and second component.

### BACKGROUND OF THE INVENTION

The present invention relates to a hinge and, more particularly, to a hinge with an adhesive.

Currently, when hinging an access panel or any type of door, welding, machining, and drilling may be required to attach the hinge. This requires mounting hard ware and a substantial amount of time to attach the hinges. Further, since the hinges are permanently mounted, the location of the hinges is limited.

As can be seen, there is a need for a device for easily hinging two components together.

### SUMMARY OF THE INVENTION

In one aspect of the present invention, a hinge device comprises: a first hinge leaf having a first outside surface and a first inside surface; and a second hinge leaf having a second outside surface and a second inside surface, wherein the first hinge leaf and the second hinge leaf are rotatably attached together, wherein an adhesive is applied to at least one of the first inside surface and the second inside surface.

These and other features, aspects and advantages of the present invention will become better understood with reference to the following drawings, description and claims.

### BRIEF DESCRIPTION OF THE DRAWINGS

FIG. 1 is a perspective view of the present invention shown in use;

FIG. 2 is a section view of the present invention, taken along line 2-2 in FIG. 1;

FIG. 3 is an exploded view of the present invention;

FIG. 4 is a section view of the present invention, taken along line 4-4 in FIG. 1; and

FIG. 5 is a detail section view of the present invention, illustrating the installing and removal of a bottom pin.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a hinge device with an adhesive for attachment. The present invention may include a hinge with a first leaf and a second leaf rotatably attached together. The first leaf and the second leaf may each include an adhesive. The adhesive may be used to connect the hinge to a first component and a second component and thereby hinge together the first component and second component.

The present invention may include a device that hinges two objects by using an adhesive fastening method. The present invention may include an adhesive used to attach a hinge anywhere needed for a panel or door. There is no need for drilling, machining, and welding to attach the present invention, and the present invention further gives a user the ability to optimize the location of the hinges. Further, the present invention may be a lower cost than a standard hinge, due to the different materials used.

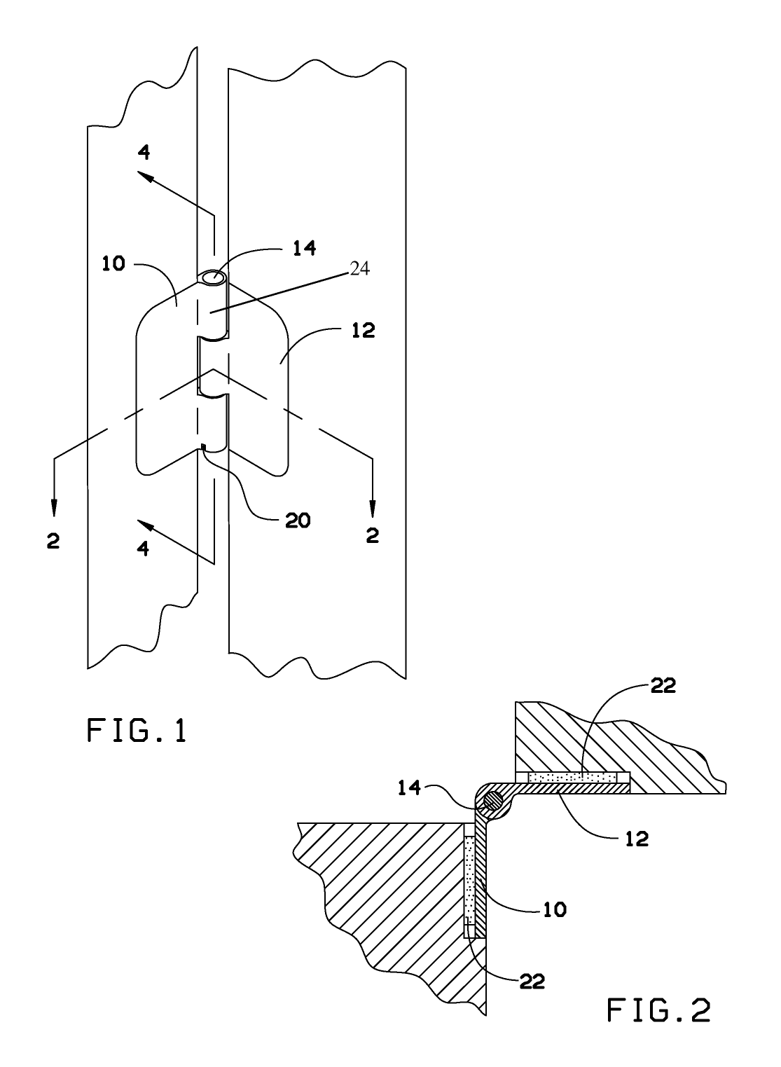

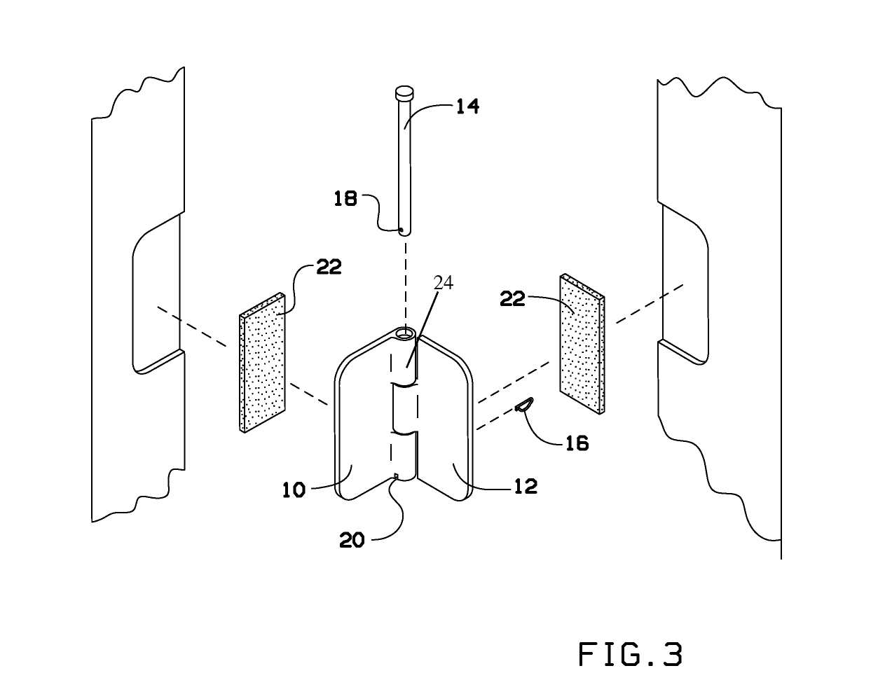

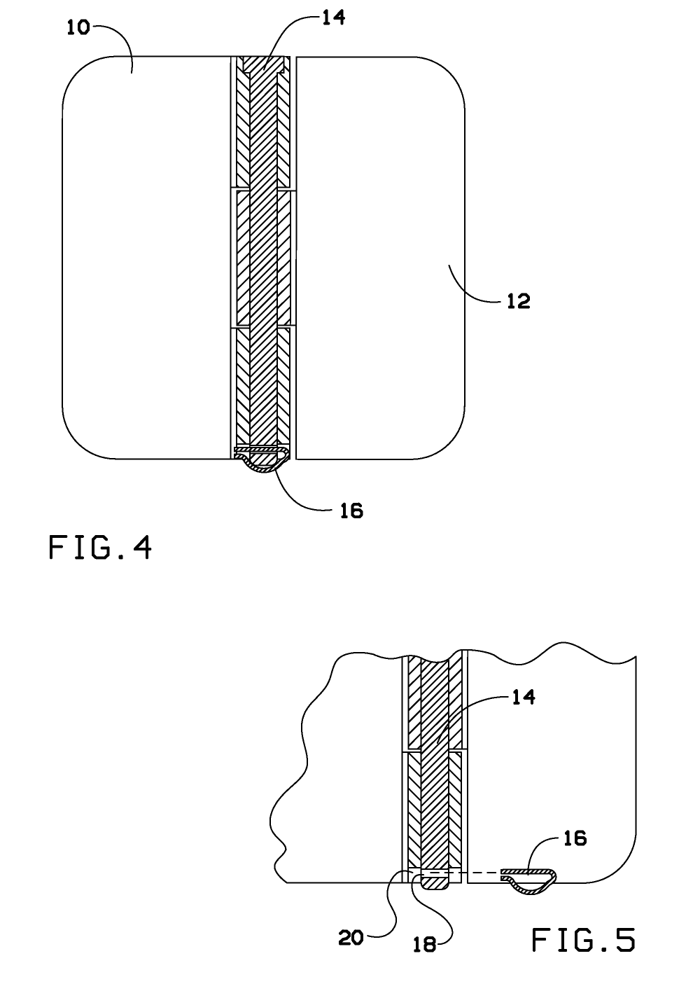

Referring to FIGS. 1 through 5, the present invention may include a first hinge leaf 10 and a second hinge leaf 12. The first hinge leaf 10 and the second hinge leaf 12 may be rotatably attached together to create a hinge. In certain embodiments, the first hinge leaf 10 may include at least one knuckle 24 and the second hinge leaf 10 may include at least one knuckle 24. As illustrated in the Figures, the first hinge leaf 10 may include two knuckles 24 and the second hinge leaf 10 may include one knuckle 24. However, either hinge leaf 10, 12 may include any desired amount of knuckles 24. The first and second hinge leaves 10, 12 may extend laterally from the knuckles 24.

In certain embodiments, a hinge pin 14 may run through the center of the knuckles 24. The first hinge leaf 10 and the second hinge leaf 12 may revolve around the hinge pin 14. The hinge pin 14 may be secured to the knuckles 24 in a various amount of ways. For example, a cotter pin slot 20 on a knuckle 24 may align with a cotter pin hole on the hinge pin 14. A cotter pin 16 may be inserted into the cotter pin hole 18 and the cotter pin slot 20 to secure the hinge pin 14 to the knuckles 24 and thereby secure the hinge together.

The present invention may include an adhesive 22 that may attach the first hinge leaf 10 to a first component and the second hinge leaf 12 to a second component, thereby hinging the first component to the second component. For example, the first component may be a door frame and the second component may be a door. The first hinge leaf 10 may include a first outside surface and a first inside surface. The adhesive 22 may be secure to the first inside surface. Thereby, the first inside surface may be attached to the first component by the adhesive 22. The second hinge leaf 10 may include a second outside surface and a second inside surface. The adhesive 22 may be secured to the second inside surface. Thereby, the second inside surface may be attached to the second component by the adhesive 22.

The present invention may be made of a metal, composite or a rigid polymer, such as plastic. The two leaves of the present invention may be created by a stamping method. The hinge pin may be a bar stock. The knuckles may be made of the same material as the leaves. However, in certain embodiments, the knuckles may be made of a self lubricating polymer. The cotter pin may be made of metal. To create the hinge from the components, the knuckles of the first leaf and the second leaf may be aligned. The hinge pin may be inserted into the knuckles. The cotter pin may be inserted into the cotter pin hole and the cotter pin slot. An adhesive may then be added to the inside surfaces of the leaves.

A method of using the present invention may include the following. A user may first attach the inside surface of a leaf to a door frame. The user may then attach the inside surface of the other leaf to a door. The door may be hinged to the frame once these steps have been completed.

It should be understood, of course, that the foregoing relates to exemplary embodiments of the invention and that modifications may be made without departing from the spirit and scope of the invention as set forth in the following claims.

What is claimed is:

1. A hinge device comprising:
a first hinge leaf having a first outside surface and a first inside surface; and
a second hinge leaf having a second outside surface and a second inside surface,
wherein the first hinge leaf and the second hinge leaf are rotatably attached together,
wherein an adhesive is applied to at least one of the first inside surface and the second inside surface.

2. The hinge device of claim 1, wherein the adhesive is applied to both the first inside surface and the second inside surface.

3. The hinge device of claim 1, wherein the first hinge leaf comprises at least one knuckle and the second hinge leaf comprises at least one knuckle, wherein the at least one knuckle of the first hinge leaf aligns with the at least one knuckle of the second hinge leaf.

4. The hinge device of claim 3, further comprising a hinge pin, wherein the hinge pin is inserted into the aligned at least one knuckle of the first hinge leaf aligns and the at least one knuckle of the second hinge leaf.

5. The hinge device of claim 4, wherein the hinge pin comprises a cotter pin hole, and the at least one knuckle comprises a cotter pin slot that aligns with the cotter pin hole.

6. The hinge device of claim 5, further comprising a cotter pin inserted into the cotter pin hole and the cotter pin slot.
